(19) United States
(12) Patent Application Publication
(10) Pub. No.: US 2020/0250759 A1
(43) Pub. Date: Aug. 6, 2020

(54) INTEGRATED PLATFORM FOR SELECT CAPITALIZATION

(71) Applicant: Dikigoroi Capital LLC, New York, NY (US)

(72) Inventors: Daniel Alpert, New York, NY (US); Arthur T. Gurwitz, New York, NY (US)

(73) Assignee: Dikigoroi Capital LLC, New York, NY (US)

(21) Appl. No.: 16/404,821

(22) Filed: May 7, 2019

Related U.S. Application Data
(60) Provisional application No. 62/800,812, filed on Feb. 4, 2019.

(51) Int. Cl. G06Q 40/06; G06Q 10/06

(52) U.S. Cl. CPC G06Q 40/06; G06Q 10/063114; G06Q 10/0635

(57) ABSTRACT

A novel computer system qualifies, manages and implements a platform directed to a structured finance product targeted to fund select risk exposures at a core group of professional organizations. The system includes data collection, approvals and default management using machine learning to provide lowered costs and risks as the system performs in the market.

### CROSS REFERENCE TO RELATED PATENT APPLICATIONS

This disclosure is based on U.S. Provisional Patent Application Ser. 62/800,812 titled Valuation And Financing Of Large Corporatized Global Law Firms, filed on Feb. 4, 2019; and incorporates by reference the contents thereof as if restated in full.

### FIELD OF INVENTION

The present invention is directed to a method and system for implementing a networked based computer system for managing capital structures to support and finance select professional practices. More particularly, the present invention provides a software/computer solution to managing a select capital structure and finance system for a large international legal practice to address risks and exposures that impact growth and profitability.

### BACKGROUND

Capital costs for business operations often depend on the nature of the business and the fixed and operating costs that it will encounter. Manufacturing typically takes substantial capital investments to build and maintain production plants. Service industries include substantial investments for labor skills and market participation. In each instance, there is typically a properly functioning capital market that can be tapped to support the business as it grows and responds to market conditions.

While the diversity of businesses that participate in the US economy is substantial, nearly all are provided unfettered access to the capital markets to raise money. The stark exception to this rule involves the legal profession. In accordance with various restrictions on ownership, law firms must be owned by the lawyers that operate the firm—and this restriction substantially limits any firm's ability to raise money in the capital markets based on equity (ownership) financing. For the most part, law firms are restricted to self-financing or borrowing money from banks triggering often costly debt loads that are often limited to short term borrowing. There are several difficulties encountered by this approach.

For example, many firms have unfunded pension obligations that exceed the capital invested in the firm. Some firms have demographic composition of their partners that skew capital contributions and holdings to soon to be retiring partners. Many firms are growing in key domestic and international markets triggering significant financial commitments in real estate and work force staffing that involve substantial cashflow demands and long term commitments.

For the largest firms in the US however, this is a serious restriction. Based on the structure and operations of these large firms, referred to as Large Corporatized Global Law Firms (“LCGL Firms”), there are certain risks and exposures that semi-permanent, third-party capital is uniquely capable of addressing. For example, many of the largest firms have long term unfunded pension obligations.

LCGL Firms typically have little to no elasticity in their occupancy and technology systems costs, and—as is the case with many large enterprises—wages prove inelastic, tending towards zero growth wage rigidity, not reduction, in recessions. As a result, to the extent that top line income suffers a decline, the only practical way for firms to maintain profitability is to reduce staffing levels. In a business in which production is generally tied to staffing, this poses a conundrum. As a result, firms have historically required equity partners to “contribute” equity capital to partially finance the WIP [work in progress] inventory and the costs of fixed investment and provide a buffer against seasonal fluctuations and recession.

The absence of a layer of third-part permanent or semi-permanent capital most distinguishes LCGL Firms from their corporate brethren. What is generally deemed to be “equity” of such firms is, in reality term subordinated debt—repayable in its entirety to partners following their retirement. Furthermore, what are generally characterized as previously unfunded retirement benefits payable to retired partners in addition to their return of capital, are substantially a promised return on capital payable to retired partners (i.e. an ordinary, albeit uncapitalized, liability of the firm—and, as a consequence, from the remaining partners to themselves) as opposed to a defined benefit annuity resulting from the deferral of compensation during working years. Firms sometimes also pay an annual return on the capital accounts of equity partners—making such equity capital even more resemble debt (i.e. paying a coupon and repayable at retirement or withdrawal), albeit with the partners' own money.

Older partners' capital, although booked as an asset, should be viewed as a liability by younger partners with decades left to work. A substantial portion of this inefficient rotation of capital in and capital out could be entirely or partially eliminated, in practice, by semi-permanent capital sources.

In a 2018 report on a survey of large law firms by Citibank N.A. Private Bank, the dominant lender to LCGL Firms and their equity partners—entitled The Equity Partnership Since 2010: Observations on Growth, Turnover and the Impact on Capital, Sep. 27, 2018—, the bank found that:

63% of large firms have a mandatory retirement age or an early retirement program with discounted benefits (often as early as age 55). Over ⅓rd of equity partners are currently at or near retirement age and own 45% of firm capital. Just 20% of current equity partners are ages 45 or younger. In ten years, 61% of the then equity partners at large firms are expected to be at or near retirement age. Such partners will own 64% of all partnership capital, which will need to be returned to them. Firms are not adding younger equity partners at a rate consistent with replacing the capital lost as baby boomers retire;

In order to keep pace with loss of capital due to retirements, large firms would—over the next ten years—need to more than double their headcount of equity partners under the age of 45. There is little evidence that firms are prepared to do, or are capable of doing, this.

These trends will likely lead to episodic and disruptively substantial capital calls and/or capital contributions. Such events have a deleterious impact on the business, reputation and stability of the LCGL Firm—a risk borne by the employee-shareholders of the enterprise.

Modern complex financial instruments are universally implemented on sophisticated computer systems. Advanced computer systems with predictive algorithms and AI are finding new applications in support of facilitating and managing capital investments and financing in general. Many key aspects of investor decisions in managing and implementing capital strategies will stem from calculations made by computers in assessing various projections or potential scenarios for both market and government/regulatory impact.

Current computers are getting faster and more powerful; but the real growth in computer management of financial and capital investment projections stems from the use of very large datasets—datasets and databases that capture changing conditions more rapidly and with finer detail and granularity with respect to trend spotting and decision-making tools. The latter capability is a programming advance that applies machine learning to system algorithms to capture and finesse key parameters as experience in the markets grows. These systems learn how to project and calculate better and more accurate views with less time.

### SUMMARY

A novel platform tracks and manages a capitalization tool for selective financing of professional organizations characterized by a restrictive ownership structure. A processing algorithm is implemented to manage and abate risk of default, thus allowing for long term structured financing, with equity attributes but no shift in ownership. The algorithm is populated with select variables that are tracked over time. The system monitors performance of the algorithm and adjusts the parameters for the variables so that risk management improves with experience and time of operation—known as “machine learning.”

The present invention has particular advantages for a select class of professional firms—a class that exhibits a unique profile of financial attributes—the LCGL Firm. These organizations are typically multi-national with revenues approaching or exceeding $1.0 billion annually. The profit margins at these organizations range in the 40-60 percent range and paid in capital is about 5-15 percent of revenue. From a tax standpoint, these are pass-through entities which restricts their ability to retain earnings from revenue to support growth and investment. As noted, legal restrictions limits ownership to attorneys that are part of the practice thus denying these entities capital sources that are otherwise available to similarly sized corporations.

In accordance with the varying arrangements of the present invention, use of capital obtained can be restricted to certain uses (such as acquiring or defeasing unfunded liabilities of the professional organization and reducing equity capital ratios, as examples). Capital pricing does not apply traditional underwriting, as there is no agreed method for risk evaluations, so the present invention incorporates a unique underwriting methodology. There are also no established NSRO [National Statistical Rating Organizations] developing rating criteria for long term financing for these firms having the attributes of unsecured debentures in a bond-like structure which is priced against risks associated with those unique to the industry. While unique in terms of underwriting, in comparison to other capital instruments, the invention enables the application of market pricing that is common across similarly structured firms using personal services as a primary revenue source.

Because of the common structure across these firms, this allows for a pricing/valuation technique based on a specialized computer programming with one or more custom pricing algorithms. This methodology tracks a select group of variables tied to the current financial performance of overall capital of the firm receiving the capital. The objective is to value the firm to permit advancement of semi-permanent long-term funding to supplement firm capital. Data on select market conditions and projections is also collected. The system initially evaluates the target firm's (i) earnings before interest, taxes, debt, service and amortization of certain expenses, as adjusted by the system's proprietary algorithm and (ii) balance sheet data, in comparison to that of industry-comparable firms. The system then determines a maximum funding level to which the target firm is eligible (together with the pricing thereof based on the credit quality determined in accordance with the immediately preceding sentence) and a set of Firm Equity Dynamic Subordination levels to which the subject financing and the target firm will be subject as a default-avoidance mechanism.

The characteristics found with the top 50 US based law firms (the so-called “AmLaw50”) provide a unified financial platform for legal services that is relatively consistent across this cohort. This allows for a single programming approach with minimal customization to generate a structured financing that can be priced on the investor side. This involves a calculation of the corporate equivalent of regulated case flow and profitability.

A separate aspect of the present invention involves mechanisms to prevent default on the structured financial arrangement. Because the business of law for the specific firms within the program and utilizing the platform is governed by a dynamic ever-changing environment, the system tracks several key variables regarding firm operations and partner compensation. A triggering event is established, and distributions to partners is curtailed (eg to 75 percent of otherwise distributable cash flow) during the episode involving financial stress to the firm.

In lieu of conventional default covenants, the high operating profit margins of LCGL Firms, and the very high ratio of unencumbered cash flow relative to anticipated debt service and other financial obligations, the computer system employs a dynamic subordination mechanism that ensures the maintenance of covenants by increasing (or, in certain cases, decreasing) firm equity capital in graduated steps. This Firm Equity Dynamic Subordination mechanism (FEDS mechanism) triggers well in advance of a potential disruption in the performance of the structured financial instruments governed by the platform. This includes diverting cash flow to build up equity in order to maintain system selected ratios protecting the investors from default.

While the system provides an early warning subroutine that facilitates greater financial oversight, it is primarily intended to reposition risk and maintain funding performance, as opposed to being a precursor to a possible default. The system parameters are set to make default a very remote possibility, if not an impossibility, in a well-managed LCGL Firm.

In one illustrative embodiment, operation of the default prevention mechanism is divided into (a) “restorative” covenants—intended to build sufficient additional equity capital to restore the ratios covered in the covenant tests to the status quo before such covenants are triggered, and (b) “protective” covenants, designed to limit distributions to equity partners until the condition that caused the covenant breach is cured.

If a restorative covenant is triggered, the increase in equity required under such covenant will be spread over a pre-determined period (eg, 12 months).

### FIGURES OF DRAWINGS

FIG. 1 is a schematic block diagram of the computer system utilized to support and monitor market data and financial accounts associated with the present invention.

FIG. 2 is a process flow diagram depicting account formation and qualification processing within one embodiment of the inventive computer system.

FIG. 3 is a process flow diagram depicting processing associated in pricing capital and managing investment tracking on the institutional side; and

FIG. 4 is a process flow diagram depicting account monitoring and managing default risk in accordance with one arrangement of the present invention.

### DETAILED DESCRIPTION

Briefly in overview, in one illustrative arrangement a client firm seeks entry into the platform. Processing begins by data collection regarding client firm financial and operational characteristics. Updated market data is accessed. A first threshold test is applied to determine if the platform is appropriate to the client firm under current market conditions. A structured note is created based on select inputs regarding the financial characteristics of the client firm and in particular the obligations and future funding requirements facing the client firm. Preferably, but not necessarily, the note is of a term of 15 years with interest only payments for the first 12 years with a three-year amortizing tail. Refinancing is triggered at the 12-year mark to allow near continuous funding without interruption.

A second pass is triggered after firm engagement and various parameters to the structured finance have been resolved. Operation shifts to account monitoring mode. Account activity is tracked and recorded. This is traditional bookkeeping with records stored to allow client monitoring. At select intervals the system pulls the key parameters to discern a stressful condition to the firm finances; if select parameters are met, the system triggers a default prevention mechanism that modifies the capital/distribution rates for the firm, retaining and often growing the financial buffer necessary to prevent default. These new parameters dictate the cash withdrawal profiles for firm members.

As operations grow, experiences are tracked and stored; and the default algorithms adjusted to more precisely maintain the appropriate buffers while reducing the incidence and volatility associated with firm financial stresses.

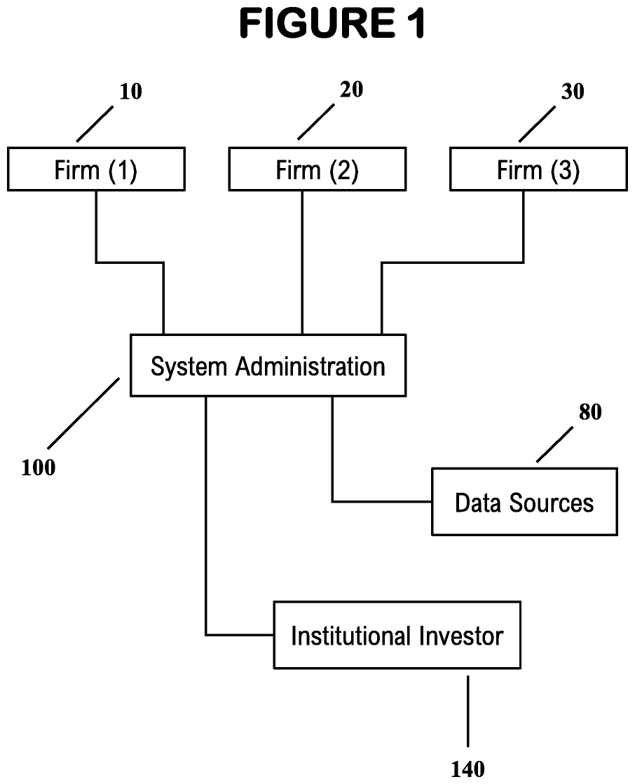

Turning now to FIG. 1, The primary functional blocks for the inventive platform are disclosed. Activities center around the computer systems managed by the System Administrator 100. Multiple firms—here Firms (1)-(3) are depicted by blocks 10-30—are linked to the System Administrator on a common network channel. Appropriate use of encryption and other security measures are in place to protect confidential information. The System Administrator also is connected to select data sources block 80 on market data regarding current market financial parameters including short term and long term interest rates. Finally, the System Administrator is in communication with the institutional investor side block 140 to support access to the liquidity necessary for financing multiple firms.

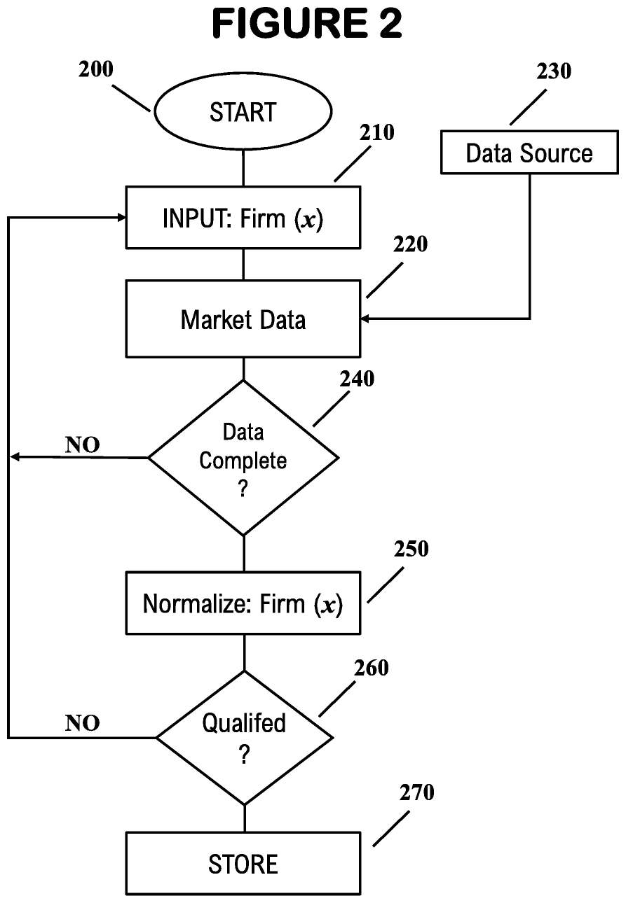

Next, continuing with FIG. 2 high level flow diagram depicts the firm qualification routine. Logic begins at start block 200 and continues to input 210 of the detailed financials for Firm(X). The data is supplemented with relevant Market Data on Firm(X) from Data Source 230 and consolidated at block 220. Test 240 confirms that the entire data set is complete—with a negative response returning logic to the collection start. At block 250, the data is normalized for all firms; and test 260 performs the qualification check. Firms qualified to participate are passed to Store 270.

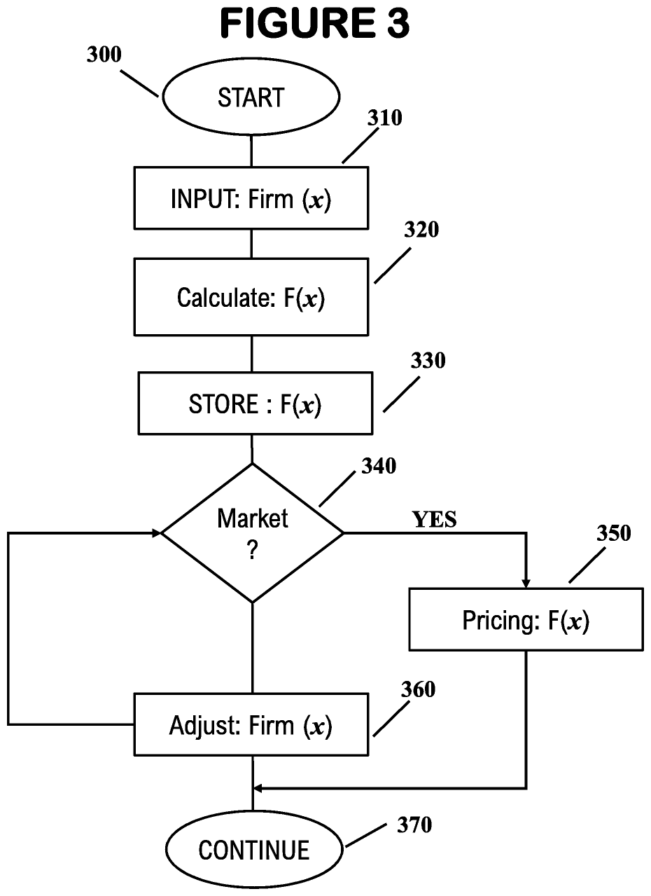

Now turning to FIG. 3 processing for final note characteristics is presented. Logic begins at start 300 and passes to the input of parameters for Firm(X). The system calculates an optimized financial package for the firm at 320; this is Stored at 330 and then passed to the market to confirm available capital at the selected parameters. If test 340 returns a positive result final pricing is completed at block 350. Otherwise, the financials are adjusted at block 360 and passed back to the Market Assessment test 340.

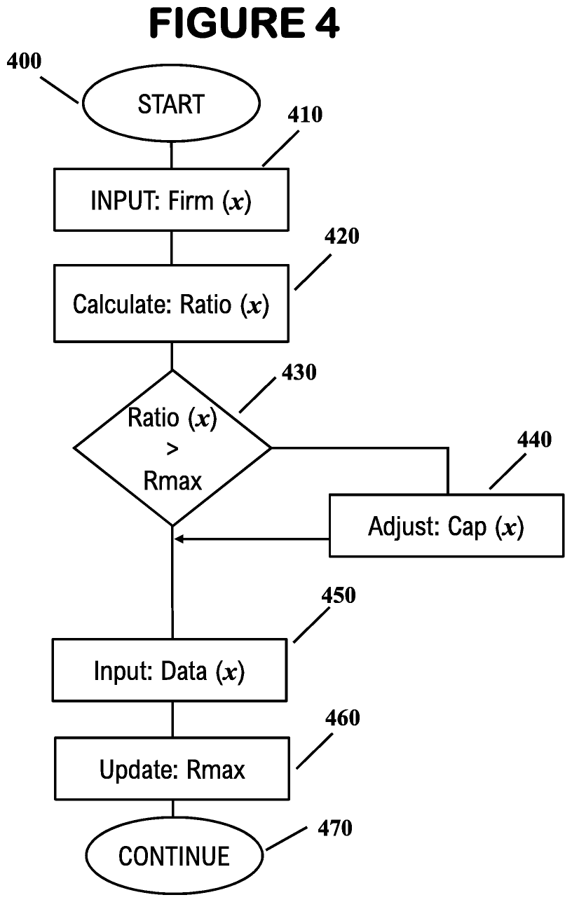

FIG. 4 provides the arrangement for dynamic adjustments of the default mechanism—for preventing defaults on the financing. Logic starts at block 400 with selection of the Firm(X) for scheduled review. Select ratios are assessed regarding current financial conditions at the firm block 420. Test 430 determines if an alarm condition exists, and if so, this will trigger various remedies including adjustments of income distributions to partners, block 440. Following the adjustment, the system assesses long term data from the database and alarm results, block 450; if an improvement opportunity is detected the system adjusts the alarm paraments in block 460. Logic continues at block 470.

The foregoing process is premised on a detailed map of the Firm and its value. One objective in valuing LCGL Firms is to ensure that the resulting calculation is more directly comparable to the valuation of a corporate enterprise. In connection with the establishment of a sustainable level of firm earnings before interest expense, non-cash costs (depreciation and amortization charges) and tax distributions, which we refer to as Adjusted EBITDA, the income statements require adjustments that:
divide equity partner distributions between (i) amounts relating to the value of such partners' labor connected with the practice of law, the marketing of the firm and other personal services, and (ii) the returns to capital and economic rents extracted by partners, owing to their equity ownership in the firm;
adjust technology and systems related expenditures—typically booked/written off somewhat irregularly for tax efficiency considerations as law firms are pass-through partnerships—to rationalize their amortization over time;
re-characterize unfunded pension obligations as capital costs, below the line (i.e. to be treated as debt obligations), to be addressed after applying a valuation multiple;
capitalize unfunded payment obligations and move the current portion below the line together with interest;
reallocate any voluntarily prepaid or contractually deferred expenses to the years in which such expenses would normally be incurred;
harmonize, with industry conventions, any unusual capitalization of items typically expensed;
finally, apply the following adjustments to gross income:
   subtract all revenues from any single client relationship that exceeds 7% of aggregate firm gross revenue;
   subtract all revenues from contingency matters in excess of 5% of aggregate firm gross revenue;

After adjusting for a corporate-comparable EBITDA, as above, a rational multiple of such Adjusted-EBITDA must be applied to determine value. There are many personal services industries that can be viewed as comparable to large law firms, and multiple-adjusted for any inconsistencies.

The system separates equity partner distributions into their compensation and profit components. In that connection, a first analysis is directed to concentration and compensation of equity partnerships in the AmLaw 50, relative to broader groups of relatively equivalently skilled attorneys. For the latter group we look to the number and profits of equity partners (profits per equity partner, or “PPEP”) in the second cohort of the AmLaw 100 (those in firms 51-100 in terms of PPEP) and in the AmLaw 101-200 (firms 101-200 in terms of PPEP). Further adjustments are made based on the level of income partner compensation within the AmLaw 50 firms.

The value of the enterprise is derived by subtracting the labor costs of equity partners in the LCGL Firm. Taking the mean value from the data sources relative to the AmLaw50 LCGL Firms enables the invention to apply its unique algorithm to obtain a labor cost derivative equal to 65.6% of profits in recent years (and subject to change with changes to underlying data on the AmLaw50 input into the algorithm). There are some firms, however, that demonstrate exceptionally high margins before equity partner compensation, because of the ability to charge premium rates, lower real estate occupancy cost per attorney, superior operating efficiencies, etc. The “trimmed” range of such margins in the AmLaw 50 is 35% to 56% which, in the higher margin firms leads to superior payouts to equity partners. Thus, maintaining the labor cost of equity partners at 65.6% without regard to potential efficiencies would be effectively penalizing the value calculation for superior management and performance.

One method for addressing the foregoing is to subtract 1% from the 65.6% labor cost of equity partners for each percentage point that the pre-equity partner compensation margin exceeds 50%. For example, the calculated labor cost of equity partners in a firm with a 56% margin at 59.6% (65.6% less 6%).

Accordingly, an assessment of the labor cost of equity partners in LCGL Firms marked at between 59.6% and 65.6% of PPEP is used to compute Adjusted EBITDA and generates a commercially and economically reasonable representation of the true profitability of such law firms.

Valuation challenges are addressed using one or more less common analysis, as there are no existing set of generally acceptable cash flow multiples in use for the fair market valuation of law firms.

Business enterprises are valued on a number of metrics. Companies in intensive growth phases are often valued on a multiple of sales or net sales revenue—or other metrics unrelated to profitability. Traditional secondary market equity valuations for public companies are often expressed as a multiple of net income or earnings per share. Most frequently, however, total enterprise value is assessed as a multiple of cash flow before interest and taxes, generally expressed as EBITDA.

LCGL Firm EBITDA (conventionally determined in accordance with U.S. or other accounting principles) is adjusted (as set forth in [0037]) to make it comparable to that of other enterprises. Value, even private value of companies with restricted ownership, can be determined by applying a multiple consistent with market-accepted multiples for other business services companies (with appropriate adjustments to such so-called “comparable” multiples, to reflect differences in profitability, capitalization and other factors including, but not limited to, the private and restricted nature of ownership).

In a preferred embodiment, equity valuation multiples derived from a group of comparable, publically-traded, companies is then applied to the adjusted EBTIDA determined above. The constituents of this “comparables universe” presently contains 30 public companies in Law, Accountancy, IT Consulting, Investment Banking, Risk Consulting, Real Estate Services, and several other miscellaneous business services sectors. The set is updated periodically and revised to drop or add companies reflecting changes in public listing status to provide a closer approximation for comparison purposes. Other adjustments can be made with the objective to capture as close a parallel that non-legal firms can provide to LCGL Firms. The sectors included within the comparables universe, with the highest and lowest multiples are excluded and the remaining sectors are averaged resulting in a “trimmed average multiple.”

The following factors, are applied to the trimmed average multiple to make a downward adjustment in multiples applicable to LCGL Firms relative to the companies in the comparable set:
The illiquidity of non-public LCGL Firms relative to the public company comparable set;
The size of the average LCGL Firm relative to the average size of the companies in the comparable set; and
The present restrictions (actual and practical) on direct ownership of LCGL Firms.

Applying this to the EBITDA to enterprise value multiple extracted from the modified comparable set and the foregoing downward adjustments results in a final EBITDA multiple. This multiple stood, for example, at 8.9× in July of 2018.

### A Case Study—the Underwriting and Valuation of a Notional LCGL Firm

In this section, underwriting and valuation methodologies set forth above are applied to a real-world law firm. The metrics in this case study are drawn from an amalgam of top-50 LCGL Firms, which we mask behind the veil of a notional law firm we have named Hypo & Thetical LLP (H&T).

H&T is an international law firm, with offices in the United States in New York (its headquarters), Washington. D.C., Boston, Chicago, Houston, Los Angeles and Palo Alto and internationally in London, England, Frankfurt, Germany, Tokyo, Japan, Brussels, Belgium and Beijing and Hong Kong in China. The primary practices include a full array of corporate services, including mergers and acquisitions, capital markets, private equity, venture capital, equity offerings, debt offerings, restructuring and real estate and litigation, including securities litigation, intellectual property, corporate reorganizations, antitrust and white collar litigation. In addition, H&T has a strong tax practice that supports its transactional capabilities, a top tier employee compensation and benefits practice and a personal representation practice, serving high net worth individuals and families.

H&T is an AmLaw 50 firm, is regularly ranked in the top of the Chambers and Partners rankings, ranks in the top of the annual Vault Inc. surveys, and has consistently been amongst the most profitable and respected firms in the world.

The firm has 200 equity partners and 700 associates and senior counsel, for a total of 900 lawyers. Additionally, it has 100 paralegals and 765 administrative support staff. Annual revenue per lawyer is $1.3 million, resulting in total annual revenue of $1.17 billion. It has expenses before partner distributions, as detailed below, of $550 million, resulting in distributable net income of $620 million. Its profit per equity partner is $3.1 million ($620 million divided by 200 equity partners) and its net operating margin is 53%.

The expense base of $550 million is comprised of the following:

### Expenses of Hypo & Thetical LLP

| | | |
|---|---|---|
| (1) | Lawyers | 210 |
| (2) | Administrative | |
| | Staff | 75 |
| | Paralegals | 7 |
| (3) | Benefits/Payroll Taxes | 40 |
| (4) | Occupancy | 70 |
| (5) | Technology | 45 |
| (6) | Business Development | 10 |
| (7) | Payments to Retired Partners | 15 |
| (8) | Interest on Capital | 3 |
| (9) | Office Operations | 25 |
| (10) | Depreciation/Amortization | 10 |
| (11) | Legal Research | 8 |
| (12) | Travel & Entertainment | 10 |
| (13) | Other | 22 |
| | Total Expenses | 550 |

In the foregoing table, lawyer compensation relates to the 700 associates and senior counsel, at an average compensation of $300,000 per annum.

The ratio of administrative staff to lawyers is 0.85, meaning that there is less than one administrative staff member per lawyer (H&T is therefore considered to be in the strata of well-managed firms relative to its peers). The average compensation per staff is $100,000, which reflects the mix towards more highly compensated technical staff.

Paralegal compensation assumes the 100 paralegals have an average compensation of $75,000. Benefits and Taxes are 15% of total compensation and include health insurance and payroll taxes.

Occupancy cost includes office space base rent plus all related expenses, including real estate taxes, cleaning, maintenance, etc. The average square foot occupancy cost per lawyer is assumed to be 800 square feet, which for 900 lawyers equates to 720,000 square feet. The average annual rent per square foot is assumed to be $85 (reflective of the firm's presence in multiple high-cost markets). resulting in annual base rent expenses of $61 million; an additional $9 million relates to real estate taxes, cleaning, maintenance, etc.

Annual average technology expenses, including software and infrastructure, primary and back-up data centers, security, hardware, etc., is $50,000 per lawyer, which equates to $45 million per year.

H&T has 50 retired partners receiving retirement payments averaging $300,000 per retired partner. The 200 equity partners have an average capital balance of $500,000, thus aggregating $100 million of capital.

General office operations are assumed to be 2% of revenue, or $25 million.

Depreciation and amortization are non-cash expenses, allowable as an income tax deduction under IRS regulations. They represent a “return” on capital investments, which for this Firm are primarily related to technology (hardware, software and infrastructure) and office buildouts. These deductions are over relatively long time frames, with a minimum of 3 to 5 years for furniture, equipment and software and up to 391/2 years for leasehold improvements.

Legal research expenses relate to the usage of databases, sold to the legal industry by major vendors. Travel and entertainment expenses are those internal, non-client expenses related to firm management travel, internal meetings, partner and lawyer retreats, etc. Other costs reflects a myriad of miscellaneous operating expenses such as professional liability and property casualty insurance, charitable contributions and staff recruiting and development.

In order to calculate H&T's value in a manner that is consistent and comparable to that of a corporate enterprise, certain adjustments are required, as set forth below. In summary, the aggregate amount of these adjustments results in a reduction of distributable net income by $410 million, which equates to $2,050,000 per partner. Thus the Adjusted EBITDA is $210 million and the Adjusted Profit per Equity Partner is $1,050,000 ($3,100,000 less $2,050,000). The specific adjustments are as follows:

System operation begins by dividing equity partner distributions between the cost of equity partner labor and the economic rents obtained from ownership (as set forth in [0040]). The analysis yields approximately 62.6% (65.6%-3% for the firm's superior profit margins, as determined pursuant to the methodology in [0041]) of the unadjusted PPEP relates to the labor cost and the remaining 37.4% to the ownership component. Thus, of the $3,100,000 of Profit per Partner, $1,940,000 relates to the labor component, and the aggregate downward adjustment is $388 million.

Technology and systems related expenses, which for income tax purposes are expensed but for this illustrative valuation methodology are reclassified more appropriately as capital expenses, with subsequent deductions for depreciation. This adjustment of $10 million is the equivalent of an increased $50,000 in PPEP.

The next adjustments pertain to unfunded pension and retirement payment obligations, which are reclassified from expenses to capital costs, to be treated appropriately as debt obligations in the system's pro-forma balance sheet analysis for purposes of calculating loan coverage. For H&T, the adjustments are $15 million for unfunded pension obligations to retired partners resulting in an increase of $75,000 in PPEP and $5 million for unfunded payment obligations relating to an older, discontinued defined benefit plan, increasing PPEP by $25,000.

Next, the system reallocates voluntary or contractually prepaid expenses from the current year into the year in which such expenses would normally be incurred. This type of practice is specific to a particular firm's culture and reporting customs. For purposes of H&T, it is assumed that it regularly accelerates $10 million of expenses, which is deducted to reduce $50,000 in PPEP.

Adjustment five deals with the treatment of capital items that, in a corporate environment, would be expensed. In this example, this relates to treatment of agency fees incurred for the acquisition of lawyer talent, including partner groups, individual partners and associates. The $15 million adjustment is the equivalent of an $75,000 reduction in PPEP.

The final adjustments relate to revenue that results from either a concentration of business or non-recurring matters. There exists some risk of instability if revenue from any one client exceeds 7% of aggregate firm business and when revenues derived from contingency matters (i.e., those where a firm participates financially in the outcome of a particular transaction or matter) exceeds 5% of aggregate gross revenue. The system will normalize the revenues that relate to a firm's core business and recognize/eliminate the risk of unusual relationships and practices. For the H&T firm we assume that there is a strong relationship with one client, which in the aggregate provides 10% of the firm's annual revenues. A 3% “haircut” adjustment (10% minus the 7% allowance) to revenue from that client, which equates to $35 million. Additionally, the firm has occasional Contingency matters, which resulted in revenues of 6% of the firm's total annual revenues, therefore, we adjusted downward the 1% excess over the 5% allowance, representing $12 million. The two adjustments total $47 million, representing a reduction of $235,000 in PPEP.

In addition to the foregoing income statement adjustments, it should be noted that we assume that Hypo & Thetical LLP has a $100 million line of credit, generally underutilized, negotiated with a consortium of banks, so that in the event of a material economic decline affecting the overall economy, or a particular temporary decline in the firm's business, there is a two-month expense cushion.

As noted above, the foregoing adjustments result in H&T showing an Adjusted EBITDA of approximately $210 million. Thus, the fair market value of H&T (approximately $1.87 billion) is calculated, using the multiple that was extant in July 2018 (as described in [0048]):

### $210,100,000×8.9=$1,869,890,0110

Applying an Adjusted EBITDA of $210 million per annum, and a valuation of nearly $2 billion, positioning several hundred million dollars of long-term capital (especially using structural mechanisms discussed below) would be well within market risk tolerance levels. The following demonstrates the benefit to Hypo & Thetical LLP of obtaining $100 million of capital (with an additional $100 million of stand-by, pari passu revolving credit available for interim liquidity needs) for the limited purposes of reducing equity partner capital levels and tendering for unfunded obligations to retired partners.

The structured finance is formatted for 12 years at a cost of funds of 5% per annum.

Additional assumptions: 50 retired partners owed benefits averaging $300,000 each per annum for life, 25 such partners initially accept a lump sum payoff equal to 50% of the payments they would otherwise receive based on an actuarial average of 12 years of remaining life expectancy (see discussion of retired partner liquidity preferences, below). Also, the forgoing buyout offer continues and is accepted, on an ongoing, basis, by an average of 50% of retiring equity partners each year.

The forgoing buyout program results in forecast savings to the firm of $125 million over 12 years of the financing and an additional $56.5 million (present valued to the final year of the financing, in connection with retiree buyouts that occurred during the term of the financing but the benefits from which continue thereafter).

Using these values, the balance of the funds available, after transaction costs, are applied to an initial $53.5 million return of capital to equity partners, which, together with a $57.5 million reduction in the magnitude of future capital assessments, reduces equity capital of the firm over time to 3.0% from 8.6% of revenues.

Based on a 3% per annum non-compounded imputed return on increased (after tax) cash to equity partners, the approach provides partners another $29 million of earnings.

Thus, obtaining $100 million in the form of financing described hereafter in this paper would result in improvements to the financial position of this hypothetical LCGL Firm's equity partners of over $92 million, after all interest and transaction costs and after repaying the financing, as detailed in the following table. If the financing is rolled over after 12 years, many of these benefits would continue to accrue.

### Proposed Market Loan Structure and

### Firm Equity Dynamic Subordination System

System operation follows two principle options for the modeling long term financing for LCGL Firms: Conventional senior unsecured long-term bond debt; and a debt/equity hybrid in the form of a structured preferred equity investment.

### Unsecured Bond Structure

With respect to a capital markets-clearing structure for long term debt capital, below is an illustration of a fixed interest rate, long-dated debt structure, utilizing the invention, that addresses the requirements and risk tolerance of both lenders and borrowers (similar, but non-debt securities can be similarly structured):

| Description: | Senior Unsecured Bonds |
|---|---|
| Eligible Use of | 1) Reduction of existing paid-in capital |
| Proceeds (as | to not less than 3% of firm revenue; |
| referred to | 2) Partial return of capital to equity |
| in [0018]): | partners; |
| | 3) Full or partial buyout of unfunded |
| | pension obligations to retired partners; |
| | 4) Funding of cash portion of prices paid |
| | to facilitate merger or acquisition activity and |
| | minimize dilution therefrom; and |
| | 5) Establishment of working capital |
| | reserves. |
| Borrower: | LCGL Firms organized as a limited liability |
| | partnership or professional corporation. |
| Term: | 15 years |
| Debt Service: | Generally 12 years interest only, payable |
| | quarterly, with a three year even amortization |
| | “tail.” Expected refinancing at end of interest |
| | only period. To the extent the bonds are not |
| | refinanced at the end of the interest only |
| | period, the bonds amortize in 12 equal |
| | quarterly payments commencing with the. |
| | first quarter following the twelfth anniversary |
| | of issuance. |
| Master Facility: | Bond facility structured to permit multiple |
| | drawdowns against a maximum borrowing |
| | base formula for the aggregate of all advances |
| | made under the bond facility. |
| Interest: | Fixed rate, based on market conditions. |
| Covenants: | See section on Firm Equity Dynamic |
| | Subordination, below. |
| Loan to Firm | Not to exceed 25% of value of firm, as |
| Value: | determined in accordance with the valuation |
| | formula described in section II, above. |
| Interest Coverage: | Adjusted EBITDA to be a minimum of 7.5× of |
| | the total of (a) annual interest on the bonds plus |
| | (b) any remaining unfunded contractual annual |
| | retirement obligations of the firm. |
| Debt Service | Same as Interest Coverage in years 1 - 12, |
| Coverage: | thereafter -assuming no growth in Adjusted |
| | EBITDA, forecast at a minimum of 5.0× total |
| | payments of interest and principal in years |
| | 13 - 15. |
| Seniority: | Senior to all other financial indebtedness of |
| | firm, other than lease obligations and |
| | installment purchase contracts. |
| Guarantee: | Bond facility to be non-recourse to equity |
| | partners, but equity partner members of the |
| | firm management committee will agree not to |
| | take any actions that conflict with the firm's |
| | performance of the terms of the financing |
| | documents. |
| Interest Revenue: | Firm to maintain, under control of bond |
| | trustee, an interest reserve sufficient to cover |
| | six month's interest. |
| Prepayment: | Closed to prepayment for five years, |
| | redeemable on a yield maintenance formula |
| | during years 6 through 10. Open prepayment |
| | thereafter. |
| Events of Default: | (1) the firm shall fail to make when due |
| | any payment of interest. |
| | (2) the firm shall fail to perform or |
| | observe any covenant with respect to it set |
| | forth in any transaction document, and in each |
| | case such failure shall remain un-remedied |
| | otherwise, thirty (30) business days after the |
| | earlier of (x) actual knowledge thereof by |
| | such person or (y) receipt by such person of |
| | written notice thereof; |
| | (3) any representation or warranty made |
| | by the firm in any transaction document or in |
| | any other document delivered pursuant |
| | thereto shall prove to have been incorrect in |
| | any material respect when made or deemed |
| | made and continues to be incorrect in any |
| | material respect for a period of thirty (30) |
| | business days after the earlier to occur of (x) |
| | the actual knowledge thereof by such person |
| | or (y) the receipt by such person of written |
| | notice thereof, and creates a materially |
| | adverse consequence to the firm; |
| | (4) an insolvency event shall occur with |
| | respect to the firm; and |
| | (5) the outstanding principal balance of |
| | the bond is not reduced to zero as of the final |
| | maturity date; |
| | (6) For U.S. federal income tax purposes, |
| | the firm becomes classified as an association |
| | taxable as a corporation. |

### The Firm Equity Dynamic Subordination™ (FEDS™) Mechanism

As set forth in [0022], the FEDS mechanism triggers well in advance of a potential disruption in the performance of the above Senior Unsecured Bonds, and is designed to automatically phase in funding of additional equity to restore the status quo prior to the triggering of a covenant from amounts otherwise distributable to equity partners.

While the FEDS system acts as an early warning system that would naturally encourage greater loan administration oversight, it is primarily intended to reposition risk and maintain loan performance, as opposed to being a precursor to a possible default.

The proposed FEDS mechanism is divided into (a) “restorative” covenants intended to inject sufficient additional equity capital to restore the ratios covered in the covenant tests to the status quo before such covenants are triggered, and (b) “protective” covenants, designed to limit distributions to equity partners until the condition that caused the covenant breach is cured. In the event that a restorative covenant is triggered, the injection of the additional equity required under such covenant will be spread over a period of 12 months, with an additional amount to be reserved from distributable cash flow each month. The specific FEDS mechanisms are as follows:

### Restorative FEDS Mechanisms

If the ratio of (a) Adjusted EBITDA, before lease rental obligations, to (b) total debt service plus lease rental obligations falls below 2.25×, the firm would increase equity by the shortfall between actual operating profit and the amount of operating profit necessary to restore such ratio (a “Make Whole Amount”);

If the ratio of (a) the firms value determined annually in accordance with the formula set forth in section II hereof, declines below (b) 3.5 times the total of the firms aggregate debt obligations plus the present value of all fixed lease obligations (using the loan interest rate as a discount rate), the firm would increase equity by a Make Whole Amount sufficient to reduce the denominator (b) to a level at which the foregoing multiple is restored;

If the ratio of paid in equity capital to total revenue declines below 5%, then the firm would increase equity by a Make Whole Amount sufficient to restore equity capital to 5% of total revenue (adjusted for protective covenants, below); and

The revenue from the top client relationship of the firm exceeds 10% of firm aggregate revenue over any rolling 24-month period, then the firm would increase equity by an amount equal to the positive difference between the revenue received from the firm's top client and 10% of the firm aggregate revenue over such 24-month period.

### Protective FEDS Mechanisms

In the event that a Protective FEDS test is triggered, distributions to equity partners would be restricted to 75% of amounts available for distribution, until the condition giving rise to the covenant trigger is cured.

The firms realization rate, defined as amounts billed to clients versus amounts actually received), over any rolling 12 month period declines below 80%;

Average billable hours logged by all timekeepers over any rolling 12 month period declines by more than 15%;

As of January 31 of each calendar year (or 30 days following the end of non-calendar fiscal years, if applicable) more than 10% of the firms accounts receivable are delinquent 90 days or more;

The total of (a) accounts receivable, plus (b) unbilled time exceeds 40% of total annual revenue, with the latter calculated on a rolling 12 month basis; and

The difference of (a) equity partners leaving the firm minus (b) new equity partners created or acquired, over any 12 month rolling period exceeds 15% of the number of equity partners in the firm.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claim is:

1. A programmed controlled system for managing and implementing a capital finance structure, comprising:
a database with detailed data relating to one or more large global professional firms and said firm business and market information;
a network-based platform including processing programmed to qualify one or more of said firms for select long term financing based on cash flows and equity partnership characteristics unique to that firm; and
a processing module within said platform for tracking firm operations on a periodic basis and implementing an alarm system triggering select covenants to further buffer the risk of default of said firm in accord with financing.

2. The system of claim 1, wherein the covenants include:
a restorative covenant intended to build up equity capital to restore ratios covered in a covenant test to status quo before such covenant is triggered.

3. The system of claim 2, wherein when the restorative covenant is triggered, build-up of additional equity required under such covenant is spread over a predetermined period, with an additional amount to be reserved for distributable cash flow each month.

4. The system of claim 1, wherein the covenants include:
a protective covenant designed to limit distributions to equity partners until a condition that triggers the covenant is cured.

5. The system of claim 4, wherein when the protective covenant is triggered, the distributions to the equity partners are restricted to 75% of amounts available for the distribution, until the condition that triggers the covenant is cured.

6. A system for managing and implementing a finance structure for a professional firm, comprising:
a first non-transitory storage medium for storing information of a plurality of professional firms;
a processor configured to:
receive, over a network, from a second non-transitory storage medium hosted by a new professional firm, obligation information and a future funding requirement facing the professional firm;
receive, over the network, from a third non-transitory storage medium hosted by a data source, real-time market data on the new professional firm;
consolidate the received financial information and the received market data;
normalize the consolidated information;
automatically determine whether the new professional firm is qualified to participate in a structured finance platform based on the normalization;
automatically add information of the new professional firm to the non-transitory storage medium when the new professional firm is qualified to participate in the structured finance platform; and
automatically send an instruction, over the network, to the new professional firm indicating disqualification to participate in the structured finance platform when the new professional firm is not qualified to participate in the structured finance platform.

7. The system of claim 6, wherein the processor is configured to create a structured note based on select inputs regarding the obligation information and the future funding requirement facing the professional firm.

8. The system of claim 7, wherein the structured note has a term of 15 years with interest only payments for a first 12 years with a three-year amortizing trail.

9. The system of claim 8, wherein the processor triggers refinancing at a 12-year mark to allow near continuous funding without interruption.

10. The system of claim 6, wherein the processor is configured to:
calculate an optimized financial package for the new professional firm based on the obligation information and the future funding requirement.

11. The system of claim 10, wherein the processor is configured to:
automatically conduct a market assessment test by determining available capital at selected financial parameters of the optimized financial package to derive a test result.

12. The system of claim 11, wherein the processor is configured to:
complete final pricing for the optimized financial package based on the selected financial parameters when the test result is positive.

13. The system of claim 12, wherein the final pricing is based on credit quality determined in accordance with the new professional firm's (i) earnings before interest, taxes, debt, service and amortization of expenses and (ii) balance sheet data, in comparison to that of industry-comparable firms.

14. The system of claim 11, wherein the processor is configured to:
repeat the market assessment test by adjusting the selected financial parameters and determining available capital at the adjusted financial parameters when the test result is negative.

15. The system of claim 6, wherein the processor is configured to evaluate
the new professional firm's earnings before interest, taxes, debt, service and amortization of expenses and
balance sheet data, in comparison to that of industry-comparable firms.

16. The system of claim 6, wherein the processor is configured to determine a maximum funding level to which the new professional firm is eligible.

17. The system of claim 6, wherein the processor is configured to determine a set of firm equity dynamic subordination levels to which the new professional firm will be subject as a default-avoidance mechanism.

18. A system for managing and implementing a finance structure for a professional firm, comprising:
a non-transitory storage medium for storing historical financial activities of a plurality of professional firms;
a processor configured to track account activity of each professional firm:
receive, over a network, current financial information of the professional firm for scheduled review at select intervals, the current financial information including key parameters to discern existence of any alarm financial condition;
assess select ratios based on the current financial condition of the professional firm;
determine whether an alarm financial condition exists by comparing the select ratios to a triggering condition;
adjust income distribution to at least one member of the professional firm when the select ratios meet the triggering condition;
assess long term data when the select ratios meet the triggering condition; and
adjust the trigger condition when an improvement opportunity is detected.

19. The system of claim 18, wherein the processor is configured to trigger a default prevention mechanism that modifies capital/distribution rates for the professional firm which retain or grow a financial buffer necessary to prevent default of the professional firm.

20. The system of claim 18, wherein the key parameters dictate cash withdrawal profiles for firm members.
